(19) United States
(12) Patent Application Publication
(10) Pub. No.: US 2004/0112751 A1
(43) Pub. Date: Jun. 17, 2004

(54) Multidimensional electrophoresis and methods of making and using thereof

(76) Inventors: Jongyoon Han, Bedford, MA (US); Anup K. Singh, Danville, CA (US)

Correspondence Address: Suzannah Sundby, Smith, Gambrell & Russell, LLP., Suite 800, 1850 M Street, N.W., Washington, DC, 20036, US

(21) Appl. No.: 10/646,808

(22) Filed: Aug. 25, 2003

Related U.S. Application Data
(60) Provisional application No. 60/405,744, filed on Aug. 26, 2002.
(60) Provisional application No. 60/422,868, filed on Nov. 1, 2002.

(51) Int. Cl. G01N 27/453

(52) U.S. Cl. 204/605; 204/610

(57) ABSTRACT

Disclosed herein are multidimensional electrophoresis devices and methods of using thereof. The multidimensional electrophoresis devices comprise short microchannels having lengths of less than about 1 millimeter to about 5 centimeters. The microchannels may comprise solid sieving medium having different sieving characteristics. IEF and PAGE, including SDS-PAGE and native PAGE, using the multidimensional electrophoresis devices takes only a few minutes or less to perform.

### CROSS-REFERENCE TO RELATED APPLICATIONS

This application claims the benefit of U.S. Provisional Patent Application No. 60/405,744 filed 26 Aug. 2002, which names Anup K. Singh and Jongyoon Han as inventors and U.S. Provisional Patent Application No. 60/422,868 filed 1 Nov. 2002, which names Anup K. Singh and Jongyoon Han as inventors, both of which are herein incorporated by reference in their entirety.

### BACKGROUND OF THE INVENTION

1. Field of the Invention.

The present invention generally relates to multidimensional electrophoresis devices and methods of making and using thereof.

2. Description of the Related Art.

Multidimensional electrophoresis, such as two-dimensional (2D) gel electrophoresis, is commonly used to analyze samples of biomolecules, such as protein mixtures. Typically, 2D protein separation is a tandem combination of isoelectric focusing (IEF) and polyacrylamide gel electrophoresis (PAGE) including sodium dodecyl sulfate polyacrylamide gel electrophoresis (SDS-PAGE) and native PAGE, although it is possible to use other combinations. See Rocklin, R D, et al. (2000) Anal. Chem. 72:5244-49; Gottshlich, S C, et al. (2001) Anal. Chem. 73:2669-2674; and Herr, A E, et al. (2003) Anal. Chem. 75:1180-1187. However, the 2D gel electrophoresis methods known in the art are generally labor-intensive, hard to automate, and macroscopic in size.

Miniaturization of 2D gel electrophoresis, the most widely used technique in proteomics, has attracted much attention as it holds the promise of significantly reducing the analysis time and the amounts of sample needed for analysis of complex protein mixtures, and has the potential to be automated and portable. A microchip-based fluidic architecture may also be easier to interface with a mass spectrometer.

A number of articles have appeared on performing IEF and SDS-capillary gel electrophoresis (CGE) in microchips. See Mao and Pawliszyn (1999) J. Biochem. Bioph. Meth. 39:93-110; Macounova, K. et al. (2000) Anal. Chem. 72:3745-3751; Raisi, F, et al. (2001) Electrophoresis 22:2291-2295; Wu, X Z, et al. (2001) Electrophoresis 22:3968-3971; Wu, X Z, et al. (2002) Electrophoresis 23:542-549; Yao, S, et al. (1999) PNAS USA 96:5372-5377; Bousse, L, et al. (2001) Anal. Chem. 73:1207-1212; Jin, L J, et al. (2001) Anal. Chem. 73:4494-4999. A prototype 2D protein separation (IEF and SDS-CGE) device was demonstrated recently, although in an unintegrated form an IEF gel has to be moved and stacked on top of a SDS-PAGE chip before carrying out the second dimensional separation. See Chen, X, et al. (2002) Anal. Chem. 74:1772-1778.

Unfortunately, prior art IEF and PAGE separations in microchips use relatively long channels, thereby making their combination result in a chip that is several centimeters by several centimeters. The long channels significantly reduces the yield of chips and also results in longer analysis time.

Separations of SDS-coated proteinon a microchip reported to date use liquid gel, and generally require relatively long (about 5 cm) channels. The liquid sieving gel has an advantage that it can be replaced after each runs, but at the same time it makes the integration into a higher level system more challenging as the liquid sieving gel can flow and diffuse into other channels. Furthermore, adding gel or sieving material to the microchip channels is difficult and challenging.

Another barrier in developing microfluidic 2D protein separation systems is the proper isolation of the two separation schemes as IEF and SDS-PAGE require the use of a unique set of reagents and buffers that are incompatible with the each other. For example, sodium dodecyl sulfate (SDS) interferes with the isoelectric focusing of the protein samples. Additionally, in isoelectric focusing, the channel length is irrelevant to the resolution of separation. However in reality, slight variation of fluidic reservoir levels cause a fluidic drift in a short IEF channel, which make IEF difficult to achieve. Furthermore, current isoelectric focusing of protein in a gel or capillary system that is typically larger than 10 cm takes about 30 minutes to an hour to focus proteins. Also, in a capillary IEF system the peaks must be mobilized for detection, thereby requiring more time for detection.

Thus, a need still exists for multidimensional separation devices for analyzing protein and methods of making and using thereof.

### SUMMARY OF THE INVENTION

The present invention relates to a multidimensional electrophoresis device for separating or analyzing a fluid sample. In preferred embodiments, the fluid sample contains at least one protein.

In some embodiments, the present invention relates to a multidimensional electrophoresis device, for isoelectric focusing (IEF) or polyacrylamide gel electrophoresis (PAGE), or both of a fluid sample, comprising at least one microchannel having a length and a solid sieving material. The PAGE may be dodecyl sulfate-polyacrylamide gel electrophoresis (SDS-PAGE) or native PAGE. In preferred embodiments, the length of the microchannel is about 1 millimeter to about 5 centimeters, preferably about 1 millimeter to about 2 centimeters, preferably about 1 millimeter to about 1 centimeter, more preferably about 1 millimeter to about 7 millimeters, and most preferably about 1 millimeter to about 5 millimeters. The solid sieving material may be a solid polymer gel.

The multidimensional electrophoresis device of the present invention may further comprise a loading structure. The loading structure may be shared with at least two microchannels.

The multidimensional electrophoresis device of the present invention may further comprise a cross channel through which the fluid sample may be electrokinetically injected into the microchannel.

The multidimensional electrophoresis device of the present invention may further comprise a channel through which at least one reagent may be added and come into contact with the fluid sample. The reagent may be a dye, a label, or a buffer solution.

The microchannels of the multidimensional electrophoresis device may further comprise at least one bypass fluidic channel.

The multidimensional electrophoresis device of the present invention may further comprise at least one chamber wherein the sample to be tested can be processed or chemically modified prior to being separated or analyzed.

The multidimensional electrophoresis device of the present invention may further comprise at least one chamber that contains at least one reagent for conducting IEF, SDS-PAGE, or native PAGE.

The multidimensional electrophoresis device of the present invention may further comprise at least one microchannel having a polymer such as polyacrylamide that was polymerized by UV initiation.

The multidimensional electrophoresis device of the present invention may further comprise a plurality of microchannels containing polymers, such as polyacrylamide, that may have pores of different sizes. In preferred embodiments, the polymers are made by UV-initiation. In some preferred embodiments, the polymer is polyacrylamide. In some preferred embodiments, the photoinitiator is 2,2′-Azobis (2-amidinopropane) dihydrochloride.

The multidimensional electrophoresis device of the present invention may comprise a plurality of microchannels and wherein the plurality of microchannels comprise different solid sieving materials. In some preferred embodiments, the solid sieving materials are of varying concentrations of at least one polymer between about 4% to about 20% (wt/vol). In some embodiments, at least one microchannel contains a gradient gel where the concentration of photoinitiated polymer changes from a low w/v percentage to high w/v percentage from one end of the microchannel to the other. In some embodiments, at least one microchannel contains a gradient gel where the concentration of at least one photoinitiated polymer changes from about 4% w/v percentage to about 20% w/v percentage from one end of the microchannel to the other.

In some preferred embodiments, the multidimensional electrophoresis device of the present invention comprises at least one microchannel for IEF separations and at least one microchannel for SDS-PAGE, or native PAGE separations.

The multidimensional electrophoresis device of the present invention may further comprise at least one polymeric membrane which isolates at least two microchannels. In some embodiments a polymeric membrane may be formed or placed on top of the microchannel wherein pressure applied to the polymeric membrane will close the microchannel, prevent fluid or current movement through the microchannel, or both.

In preferred embodiments IEF, SDS-PAGE, or native PAGE takes about 5 minutes or less, preferably about 2 minutes or less, preferably about 1 minute or less, more preferably about 30 seconds or less, most preferably about 10 to about 30 seconds to perform using the multidimensional electrophoresis device of the present invention.

In some embodiments, the multidimensional electrophoresis device of the present invention allows IEF to be conducted in at least one horizontal microchannel between two electrodes and SDS-PAGE or PAGE to be conducted in at least one vertical microchannel between two pairs of electrodes, wherein one pair of electrodes is placed above the two electrodes of the horizontal microchannel and the other pair of electrodes is placed below the two electrodes, whereby conducting IEF when the electrodes on the right side are of one voltage and the electrodes on the left side are of another voltage prevents the fluid sample from migrating through the vertical microchannel.

The present invention also provides assay methods for analyzing fluid samples which comprises using a multidimensional electrophoresis device as disclosed herein.

The present invention further provides kits for analyzing a fluid sample which comprises a multidimensional electrophoresis device as described herein packaged together with at least one reagent necessary for conducting IEF or PAGE separations. The kits may further comprise a device for injecting the fluid sample into the multidimensional electrophoresis device. In some embodiments, the kits may comprise a label, at least one reagent, at least one device, or at least one means for obtaining a visually observable result. In some embodiments, the kits may further comprise instructions for using the multidimensional electrophoresis device.

It is to be understood that both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention and together with the description serve to explain the principles of the invention.

### DESCRIPTION OF THE DRAWINGS

FIG. 1 shows isoelectric focusing in 4 mm microchannel.

FIG. 2A is an example of a thinner IEF microchannel that has a higher fluidic resistance than the other thicker microchannels and a side bypass channel that relieves the pressure developed across the IEF microchannel.

FIG. 2B shows a design similar to that shown in FIG. 2A, but without the side bypass channel.

FIG. 3 shows an inverted grayscale image of a glass microchip with in situ polyacrylamide gel localized in the separation channel. The inset shows the interface between the microchannel and the gel.

FIG. 4A shows an example of two microchannels attached to a single loading structure.

FIG. 4B shows three microchannels attached to a single loading structure.

FIG. 4C shows a complex conformation of multiple microchannels having a single loading structure.

FIG. 4D shows two parallel microchannels having different gel concentrations.

FIG. 4E shows two parallel microchannels and a channel through which a dye may pass.

FIG. 5 shows a single loading structure for three microchannels having different gel concentrations.

FIG. 6A shows two SDS-PAGE separations of six proteins in a 12% gel.

FIG. 6B graphically shows the distance of each protein (peak) from the gel interface at 26 seconds after launching for the gel shown in FIG. 6A.

FIG. 7A shows an image at 0 second, wherein mixed proteins were loaded (white band) into the microchannel and launched.

FIG. 7B shows of the original size of injected band at 3 seconds (about 250 um) before it enters the gel.

FIG. 7C shows stacking of proteins into a sharper band (about 25 um) upon entering the gel and separated protein bands at 8 seconds.

FIG. 7D shows separation of proteins at 15 seconds.

FIG. 8 is a graph showing a plot of mobility versus electric field. The y-axis is log(μ/μ_{dye}), where μ is the mobility of the proteins, while μ_{dye} is the mobility of the dye (Bromophenol blue) molecule.

FIG. 9 shows an empty cross channel fabricated over the microchannels to provide pressure to the microchannels, thereby resulting in closure of the microchannels.

FIG. 10 shows a valveless multidimensional electrophoresis device comprising six independent fluidic reservoirs/electrodes, A-G.

FIG. 11 shows an image of SDS-PAGE separation of three FITC-labeled cytokines.

FIG. 12A shows an electropherogram of native PAGE of five fluorescent proteins. The inset shows an inverted gray scale CCD image of the proteins beginning to resolve just after about 6 seconds after injection.

FIG. 12B shows an electropherogram of native PAGE of an unpurified IL-2 sample. The inset shows inverted gray scale CCD images of the sample at various times and various locations during the separation.

FIG. 13 schematically shows how the valveless multidimensional electrophoresis device may be constructed using a two-level method.

### DETAILED DESCRIPTION OF THE INVENTION

The present invention is directed to a multidimensional electrophoresis device for isoelectric focusing (IEF) and polyacrylamide gel electrophoresis (PAGE) including sodium dodecyl sulfate-polyacrylamide gel electrophoresis (SDS-PAGE) and native PAGE protein separation and methods of making and using thereof. The multidimensional electrophoresis device the present invention provides: (1) rapid separation of protein peaks, e.g. about 30 seconds; (2) decreased electric potential applied across the microchannel since a microchannel length of less than about 1 cm may be used; (3) a microscope optic may be used for imaging of the microchannel in real time for a faster analysis, thereby allowing the analysis of multiple protein peaks, e.g. about 1,000 or more; and (4) use of a solid sieving material such as solid polyacrylamide gel instead of liquid sieving matrix.

In some embodiments, the multidimensional electrophoresis device of the present invention has microchannels of about 1 millimeter to about 5 centimeters. In preferred embodiments, the length of the microchannel is about 1 millimeter to about 2 centimeters, preferably about 1 millimeter to about 1 centimeter, more preferably about 1 millimeter to about 7 millimeters, and most preferably about 1 millimeter to about 5 millimeters. In some embodiments, using the multidimensional electrophoresis device of the present invention to perform an assay or a separation takes only a few minutes, preferably less than about two minutes, more preferably less than about one minute, even more preferably less than about 30 seconds.

As used herein, “microfluidic channel” is used interchangeably with “microchannel” to refer to a channel of sufficient size to allow a fluid sample pass through, preferably a microchannel generally in the form of a tube that has mean cross-sectional measurement of about 1 mm or less, preferably between about 1,000 μm and about 1 μm, more preferably between about 500 μm and about 1 μm, most preferably between 100 μm and about 5 μm.

The multidimensional electrophoresis device of the present invention may be used to analyze a fluid sample comprising a mixture of various proteins, including very short or very long ones, with a single loading and electrophoresis run. As used herein, “assaying” is used interchangeably with “detecting”, “measuring”, “monitoring” and “analyzing”. As used herein, a “fluid” refers to a continuous amorphous substance that tends to flow and to conform to the outline of a container such as a liquid or a gas. Fluids include blood, plasma, urine, bile, breast milk, semen, water, liquid beverages, air, and the like. If one desires to test a solid sample for a given protein according to the present invention, the solid sample may be made into a fluid using methods known in the art. For example, a solid sample may be dissolved in an aqueous solution, ground up or liquefied, dispersed in a liquid medium, and the like. Alternatively, the surface of the solid sample may be tested by washing the surface with a solution such as water or a buffer and then testing the solution for the presence of the given analyte. In some situations where the analyte is a protein attached to the surface of a material, the protein may be treated with a proteolytic agent known in the art to cleave the protein or a fragment of the protein from the surface. The sample can be a biological fluid such as urine, breast milk, blood, plasma, and the like. The sample may be a prepared sample such as a cell extract or an unprepared sample of substance taken in the field, such as water suspected of being contaminated with biological warfare agents and the like.

The shorter microchannels of the multidimensional electrophoresis device of the present invention makes scanning a long (typically about 30 cm) capillary or waiting for peaks to elute unnecessary. Instead, simple microscope optics and fluorescence or UV absorption detection of the peaks focused in the microchannel (whole field imaging) may be used. Thus, the multidimensional electrophoresis device curtails the focusing and analysis time down to less than a minute. In preferred embodiments, the whole length of the microchannel may be observed with standard microscope optics.

The short microchannels of the multidimensional electrophoresis device of the present invention may be fabricated on a solid support. The microfluidic channels may be made using methods known in the art. For example, the microfluidic channels can be formed on the surface of the substrate by (1) bulk micromachining, (2) sacrificial micromachining, (3) LIGA (high aspect ratio plating) or (4) other techniques known in the art, or any combination thereof. Such techniques are well known in the semiconductor and microelectronics industries and are described in, for example, Ghandi, VLSI Fabrication Principles, Wiley (1983) and Sze, VLSI Technology, 2nd Ed., McGraw-Hill (1988); Wolf and Taube, Silicon Processing for the VLSI Era, Vol. 1, Lattice Press (1986), and Madou, Fundamentals of Microfabrication, CRC Press (1997); which are herein incorporated by reference.

The solid support is preferably made of a substrate that is suitable for micromachining or microfabrication. In preferred embodiments, the substrate is optically transparent. Suitable substrates include silicon, silica, quartz, glass, controlled pore glass, carbon, alumina, titania, tantalum oxide, germanium, silicon nitride, zeolites, gallium arsenide, gold, platinum, aluminum, copper, titanium, Zeonor, TOPAS, polystyrene; poly(tetra)fluoroethylene (PTFE); polyvinylidenedifluoride; polycarbonate; polymethylmethacrylate; polyvinylethylene; polyethyleneimine; poly(etherether)ketone; polyoxymethylene (POM); polyvinylphenol; polylactides; polymethacrylimide (PMI); polyalkenesulfone (PAS); polypropylene; polyethylene; polyhydroxyethylmethacrylate (HEMA); polydimethylsiloxane (PDMS); polyacrylamide; polyimide; and block-copolymers, and the like, and combinations thereof. In preferred embodiments, the substrate is transparent, thereby allowing optical detection.

One skilled in the art may minimize fluidic movement (and ampholyte movement) in a short IEF microchannel of the multidimensional electrophoresis device of the present invention prevents by adjusting fluidic resistances (channel depths) or providing at least one bypass fluidic channel which relieves possible pressure development across the IEF microchannel.

In some embodiments, the multidimensional electrophoresis device may further comprise at least one chamber or reservoir wherein the sample to be tested can be processed or chemically modified prior to being separated or analyzed. For example, a chamber or reservoir may contain a label for the analyte or analytes to be analyzed that is released into an area where the sample to be analyzed is present. Alternatively, the sample to be analyzed may pass through the chamber or reservoir that contains the label. In some embodiments, the multidimensional electrophoresis device comprises at least one chamber that contains reagents, such as buffers and enzymes, which are necessary for the assay being conducted.

A. Short IEF Microchannels

As disclosed in Example 1, IEF and SDS-PAGE separations in short microchannels requiring less than a minute to perform were obtained. IEF separation of several naturally fluorescent and labeled proteins was achieved with commercially available ampholyte in a microchannel, fabricated on either polydimethylsiloxane (PDMS) or glass substrates. SDS-PAGE separations were achieved in a chip by photopatterning polyacrylamide gel in a microchannel. A fluorescent protein marker sample comprising 6 proteins having a molecular weight (MW) of about 20.1 to about 205 kDa was separated in less than about 30 seconds in a microchannel having a length of less than about 1.5 mm.

In microfabricated protein separation systems, because of the small path-lengths available, proteins frequently need to be fluorescently labeled to enable sensitive detection. However, protein labeling by covalent chemistry typically involves modification of protein properties such as charge and size. The most routinely used groups in a protein for functionalization are N-terminal amines and ε-amines on lysine residues. The amines are positively charged at neutral pH and hence, attaching a neutral dye such as rhodamine to each amine results in net loss of one positive charge. As proteins contain multiple lysine residues, the isolectric point can be significantly altered upon labeling. Additionally, labeling using lysines results in multiple bands corresponding to one protein as the labeled product is a heterogeneous mixture of multiply labeled populations. See Yao, S. et al. (1999) PNAS USA 96:5372-5377, which is herein incorporated by reference.

Cysteines, on the other hand, are neutral at neutral pH. Moreover, the number of cysteines available for modification in a protein is typically quite small under non-reducing conditions (most of the cysteines undergo disulfide bridging). Hence, labeling with a cysteine-specific dye results in more homogeneous product whose pI is not significantly altered. Therefore, as disclosed in Example 1, a cysteine specific dye was used. Although a cysteine specific dye was used, other dyes, such as amine specific (e.g., naphthalene dicarboxyldehyde, fluorescamine, fluorescein isothiocyanate, TRITC), corboxylate-specific, other amino acid-specific or dyes that associate non-covalently with proteins (e.g., Nanoorange™ from Molecular Probes).

Due to the electroosmotic flow in the microchannel, focused protein peaks moved slowly toward the cathode. Also, because the IEF microchannels used herein are at least an order of magnitude shorter than prior art channels, the ampholyte-sample mixture may be driven by hydraulic pressure due to a slight difference in reservoir liquid levels. In fact, mobilizing focused peaks in either direction by controlling the catholyte or anolyte levels in the reservoirs was found to be possible.

The speed of peak movement (due to both electroosmotic flow and the hydraulic pressure due to the level difference) may be decreased or increased by changing the concentration of methylcellulose added in the ampholyte-sample mixture. Increased methylcellulose concentration decreases the electroosmotic flow by dynamic coating of the wall, and by increasing the viscosity of the ampholyte solution. Compared with prior art methods conducted with short (a few cm) capillaries, the short IEF microchannel fabricated in Example 1 (square microchannel with about a 27 μm×50 μm cross-section area) will have much higher fluidic resistance than typical capillaries (about 100 μm inner diameter) used in capillary IEF, and may be made even thinner. The high fluidic resistance of the microchannel makes the IEF separation less susceptible to the hydraulic pressure due to slight level difference in the reservoirs, thereby allowing IEF microchannels to be miniaturized down to a millimeter scale.

Miniaturized IEF microchannels provide several advantages both in analytical and practical point of view. In IEF, the separation resolution does not depend of the length of the microchannel. The focused peak width, σ, can be given as the following

$$Equation ( 1 ) \text{:} \\ σ = \sqrt{\frac{D ( ⅆ x / ⅆ ( pH ) )}{E ( ⅆ μ / ⅆ ( pH ) )}} ∼ \frac{L}{\sqrt{V}} \qquad ( 1 )$$

wherein

D is the diffusion constant of the protein,

E (=V/L, L is the microchannel length) is the electric field, and

μ is the mobility of the protein.

See Catsimpoolas, N. Isoelectric Focusing Academic Press, NY (1976), which is herein incorporated by reference.

While dμ/d(pH) is an inherent property of the protein, dx/d(pH) (pH gradient in length) scales as ˜L for a given pH range determined by the ampholyte used in the experiment. The separation resolution, Rₛ, is given as ˜d/σ, where d is the separation distance in the microchannel between the two peaks of interest. Since d also scales as ˜L, Rₛ is only proportional to V^{1/2}, independent of the length of the microchannel, L.

In other words, for a given applied potential, the separation resolution does not change as the microchannel length is decreased, because of increased field strength in the microchannel makes the focused peak narrower. However, the time it takes to achieve IEF in the microchannel is decreased, because of shorter microchannel length as well as higher electric field strength.

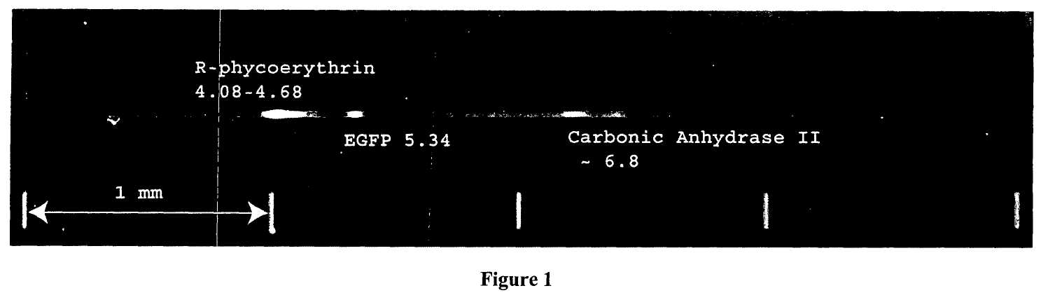

FIG. 1 shows an IEF that was achieved in a 4 mm microchannel in less than about 1 minute (about 30 seconds) after applying an electric field of 35.7 V/cm, a much shorter time compared with about 45 minutes in prior art capillary IEF. Higher field strength also means more concentrated focusing in the microchannel, which could allow more sensitive detection of the peaks. Carbonic Anhydrase II was labeled by cysteine-specific labeling (rhodamine-maleimide), while R-phycoerythrin and EGFP are naturally fluorescent. 1% methylcellulose was added to ampholyte mixture for a dynamic coating. Wider microchannel regions at both ends are filled with catholyte and anolyte, respectively, and a pH gradient was established within the 4 mm microchannel. A whole-column detection of the microchannel IEF can be easily achieved with simple microscope optics, thereby eliminating the need of mobilizing peaks in the capillary.

Although it is difficult to determine the nonlinearity with only 3 peaks, the pH gradient of the microchannel seems to be somewhat nonlinear from the FIG. 1. The nonlinearity is probably due to the different electroosmotic flow strength of the microchannel in different pH regions as it is well established that higher pH condition can induce faster electroosmotic flow. Therefore, this problem may be solved by coating the surface of the microchannel using methods known in the art in order to minimize the electroosmotic flow.

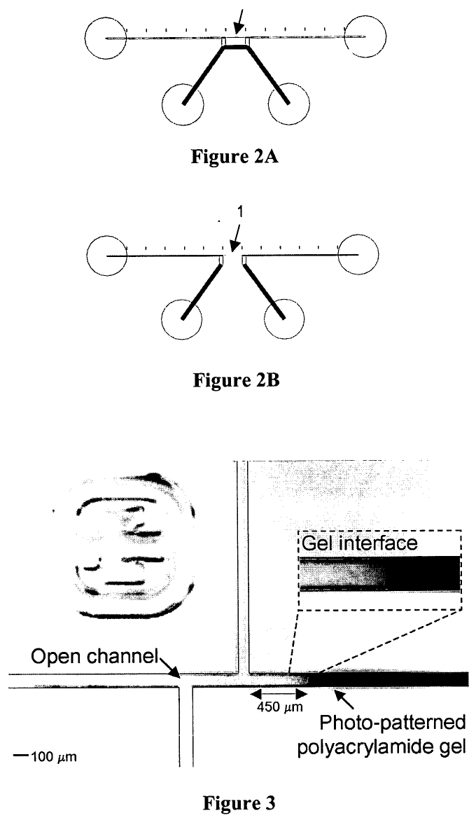

FIG. 2A is an example of a thinner IEF microchannel (1) that has a higher fluidic resistance than the other thicker microchannels. The side bypass channel relieves the pressure developed across the IEF microchannel that prevents fast ampholyte drift, thereby allowing stable isoelectric focusing. FIG. 2B shows a design similar to that shown in FIG. 2A, but without the side bypass channel. The IEF microchannel design of the present invention prevents fluidic movement of ampholyte in a short microchannel (about 1 mm to about 1 cm), thereby allowing miniaturized 2D analyte separations. Miniaturization of IEF separation down to less than about 1 cm, preferably about 7 mm down to about 1 mm lengths, allows fast detection (about 1 minute or less, preferably about 30 seconds or less, more preferably about 15 seconds or less, most preferably about 10 seconds or less) of peaks by methods know in the art, such as fluorescence microscopy or UV absorption and simple microscope optics with about a 5 mm field of view.

The multidimensional electrophoresis device of the present invention may be complexed with other detection methods known in the art such as UV detection, post-separation labeling, dynamic labeling methods, non-fluorescence techniques, and the like. See Liu, Y et al. (2000) Anal. Chem. 72:4608-4613; Swinney, K and D J Bornhop (2000) Electrophoresis 21:1239-1250; and Jin, L G, et al. (2001) Anal. Chem. 73:4994-4999, which are herein incorporated by reference.

B. Solid Sieving Medium

The use of solid polyacrylamide gel in a microchannel has been demonstrated for DNA separation (Brahmasandra, S N, et al. (2001) Electrophoresis 22:300-311, which is herein incorporated by reference) and has several advantages over liquid sieving material. Solid, crosslinked gel does not mix with or diffuse into other regions of a microchannel. In addition, solid gels have better sieving power than liquid gels, which allows faster separation within a short microchannel length. Patterned gel structures can also be used for other purposes than molecular sieving, such as sample stacking and molecular manipulation. The use of solid gels allows the construction of a multidimensional electrophoresis device, whereby multiplexing may be conducted, i.e. more than one sample may be separated and analyzed in separate gels in different microchannels in a single chip. The samples may be separated or analyzed consecutively or simultaneously.

As disclosed in Example 1, photopolymerization techniques were used to pattern a solid polyacrylamide gel for SDS-PAGE in a microchannel using an ultraviolet (UV) lamp and photomask. Compared with conventional capillary separation, an order of magnitude improvement in separation speed was achieved with the microchannels described herein, while requiring much lower electrical potential. The small sizes of the microchannels were found to facilitate the detection of separated protein bands, since the protein bands may be detected quickly by a whole-field imaging technique using optical microscopy. Thus, the peaks need not be eluted.

The solid polyacrylamide gels in microchannels as described herein provide a number of advantages over liquid gels typically used in capillaries or chips including: (1) higher sieving power and hence, smaller separation lengths, (2) the ability to carry out sample stacking, (3) no loss or mixing of stationary phase in chips with multiplexed separation, (4) the ability to perform parallel or serial analyses by casting different polymers in different parts of the same chip, and (5) the ability to cast gradient gels. Moreover, because polymerization is initiated by UV-light, the channels can be photolithographically patterned analogous to photolithography, using a mask and a UV-lamp for optimal design of injection, separation and detection manifolds. Using a mask, the polymerization is restricted to UV-exposed regions and monomers from the unexposed regions are flushed after the irradiation step. This allows polymer to be cast selectively in separation channels, while injection channels and the detection window remain open. This allows for rapid and repeatable injection, easy clean up of injection arms, and more sensitive detection. The ability to photopattern also facilitates multi-dimensional separation by enabling multiple separate stationary phases in a single chip.

Thus, in some embodiments, the multidimensional electrophoresis device of the present invention comprises at least one solid gel as the sieving medium. In some embodiments, the multidimensional electrophoresis device of the present invention may comprise at least one microchannel having a liquid polymer gel. In some embodiments, the multidimensional electrophoresis device of the present invention may have a combination of liquid and solid polymer gels as the sieving medium. FIG. 3 is an image of a glass microchip with in situ polymerized polyacrylamide gel localized in a microchannel. Normally visually undetectable, the gel contains a dye that appears black in an inverted grayscale image as shown. The inset of FIG. 3 shows the interface between the open microchannel and the gel.

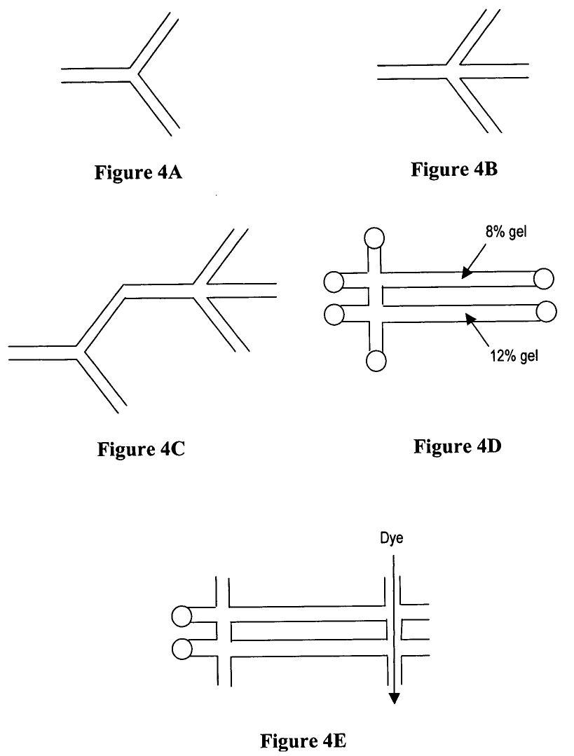

The device may have one or more microchannels attached to at least one loading structure. In preferred embodiments, the device of the present invention comprises several microchannels attached to a single loading structure. FIG. 4A shows an example of two microchannels attached to a single loading structure. FIG. 4B shows three microchannels attached to a single loading structure. As shown in FIG. 4C, a microchannel may be further separated into more than one microchannel to form a complex conformation of multiple microchannels having a single loading structure. FIG. 4D shows two parallel microchannels having different gel concentrations. FIG. 4E shows two parallel microchannels and a channel through which a dye may pass. The circles designate reservoirs which may or may not contain electrodes (preferably thin Pt wire or patterned Au thin film on the wafer) immersed in the liquid contained in the reservoir.

The devices according to the present invention may be assembled using conventional methods known in the art. Generally, microchannels are etched into a flat wafer, such as glass, using methods known in the art. Then a second wafer having holes is obtained and the holes of the second glass wafer are aligned with the end of channels in the first wafer using methods known in the art. The two wafers are aligned and bonded using methods known in the art, including thermal, anodical, or compression techniques. Reservoirs are attached on top of the holes. In some preferred embodiments, the reservoirs are attached by inserting thin glass or plastic vials with or without caps into the holes and then fixing the vials using a suitable glue or adhesive such as a UV-curable epoxy. In other preferred embodiments, plastic fittings are fixed on top of the holes using a suitable glue or adhesive such as a UV-curable epoxy. The fittings have holes through their centers and the bottoms of the fittings are aligned with the holes in the chip before fixing the fittings to the wafer. Then on the opposite sides of the holes (the sides opposite to having the fittings of vials affixed thereto), the holes are machined or manufactured such that a second piece, such as a plastic piece, may be affixed thereto. In preferred embodiments, the opposite sides of the holes have threads machined so that another piece may be screwed into the hole.

In other preferred embodiments, the devices of the present invention contain manifolds in which a wafer can be sandwiched. Such devices may be fabricated using methods known in the art. Specifically, fluidic reservoirs were fabricated from a single block of ULTEM® polymer (GE Plastics, available from various commercial vendors) or fabricated as individual reservoirs, which can accommodate up to about 1.5 ml of buffer solutions. The electrical connection between the power supplies was facilitated by an electrode plate outfitted with spring loaded electrodes to make contact to fluid electrodes which extend into the buffer solutions. The bottom of these reservoirs were sealed with a threaded septum seal. To make the fluidic connection between the fluidic manifold and the reservoirs, the septum seal was pierced by a 150 μm i.d./350 μm o.d capillary held in a ferrule which was thread compression sealed into the fluidic manifold. Each of these reservoir connections was counterbored into the fluidic manifold, fabricated from either PEEK (polyetheretherketon) or Delrin® (DuPont, available from various commercial vendors), or the like to provide electrical isolation from the various electrical channels. Beneath each counterbored connection a 500 μm hole was drilled through the manifold, which terminated at the fluid interface between the microfluidic chip. This connection between the fluidic manifold and the microfluidic chip was sealed with a silicon O-ring capable of holding off approximately 600 PSI with aqueous solutions. The microfluidic chip was mounted to the manifold using an aluminum or PEEK (for higher voltage applications) bracket mounted with a quartz backing plate in order to view the alignment of the microfluidic chip via holes to the O-ring seals on the fluidic manifold.

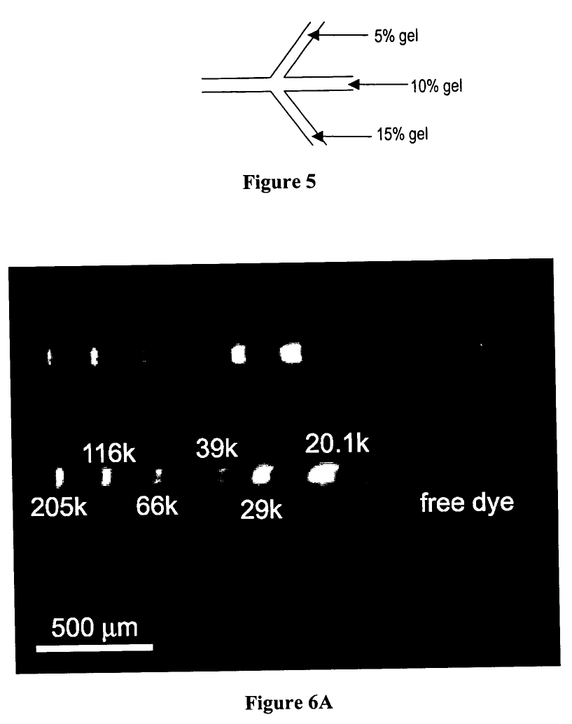

Although each microchannel on the device may have polymer gels with the same sieving characteristics (concentration), in preferred embodiments, the device comprises microchannels having polymer gels of different sieving characteristics to provide different ranges of separation. For example, FIG. 5 shows a single loading structure for three microchannels having different gel concentrations. Thus, the multidimensional electrophoresis device of the present invention that has microchannels with different sieving characteristics provides different ranges of separation such that a complex mixture of analytes, such as proteins including short and long chains may be analyzed with a single run of the device. For example, proteins with mass between about 10 kDa to about 40 kDa can be best separated by about 15% acrylamide gel, while proteins between about 30 kDa to about 200 kDa can be best separated by about 7.5% acrylamide gel. Both gels can be incorporated within a single device in this invention.

Photopolymerization techniques and compositions, such as a photoinitiator 2,2′-Azobis (2-amidinopropane) dihydrochloride (V-50 from Wako Chemicals USA, Inc., Richmond, Va.), known in the art, may be used to create microchannels of different sieving characteristics. See e.g. U.S. Pat. No. 6,391,937, which is herein incorporated by reference. Generally, an entire first microchannel is filled with a gel monomer solution at a desired concentration, and then the first microchannel is exposed to an agent that polymerizes the gel, such as UV light, to make the gel in the first microchannel solid. Then, a second gel solution of the same or second desired concentration is introduced into a second microchannel by pressure. The second gel solution does not go into the first microchannel comprising the polymerized gel due to its high fluidic resistance. Then the second microchannel is exposed to an agent that polymerizes the second gel solution. In some preferred embodiments, different concentrations of gel solutions are used to provide a microchip comprising gels of various concentrations and characteristics.

For example, a desired gel solution, for example, 5%, is added to the microchannels. Then only one microchannel or a part of a microchannel is exposed to UV light to solidify the gel in the area exposed. Next, a second desired gel solution, for example, 10% is added to the microchannels and a second microchannel or a part of a microchannel is exposed to UV light to solidify the gel in the area exposed. This process may be repeated in order to obtain microchannels of a desired configuration and concentrations. It is noted that gel solutions will not enter the areas where there are solid gels in the microchannels. Additionally, gel solutions may be flushed out of the microchannels by introducing new gel solutions or other solutions such as buffers into the microchannels.

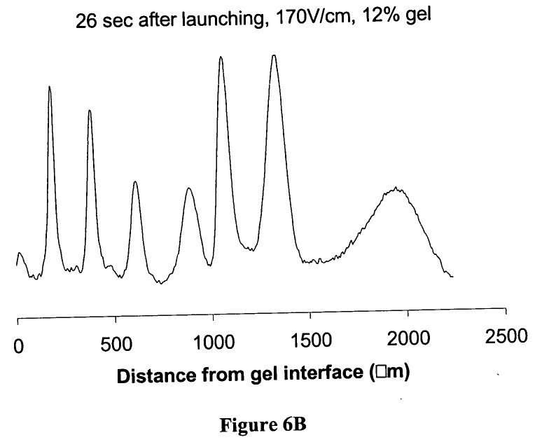

FIG. 6A shows two SDS-PAGE separations of six proteins in 12% gel (acrylamide:bis-acrylamide=37.5:1) comprising 0.1% SDS and 0.2% photoinitiator. Both microchannels contain the same concentration gels, but the difference in the location of gel boundary in the two microchannel yields slightly different peak locations. The left edge of the image roughly coincided with the beginning of gel in the microchannel. This fluorescence image was taken 25 seconds after the launching the sample from the loading area, and the electric field was 170 V/cm. Six protein peaks were well separated in both microchannels, within the microchannel distance less than about 2 mm. The gel buffer was 0.375 M Tris-Cl (pH=8.6). The six fluorescently-labeled proteins (product number F-3526, Sigma Chemical Co., St. Louis, Mo.) are myosin (205 kDa), beta-galactosidase (116 kDa), bovine serum albumin (66 kDa), alcohol dehydrogenase (39 kDa), carbonic anhydrase (29 kDa), and trypsin inhibitor (20.1 kDa). The rightmost band in the microchannel is due to the bromophenol blue dye added to the sample. The width of dye band is much larger than other protein bands, thereby suggesting no stacking effect for small dye molecules. The plate number of the separation was between about 300 to about 800, which is comparable to the plate number (about 1000) of slab gel SDS-PAGE. The plate number per length was calculated to be about 1.5 to about 4×10⁵ plate/m. Thus, it is possible to separate protein samples in less than about a minute over a distance of about 2 mm or less and the whole gel image may be viewed in its entirety under a microscope, thereby allowing faster detections and analysis.

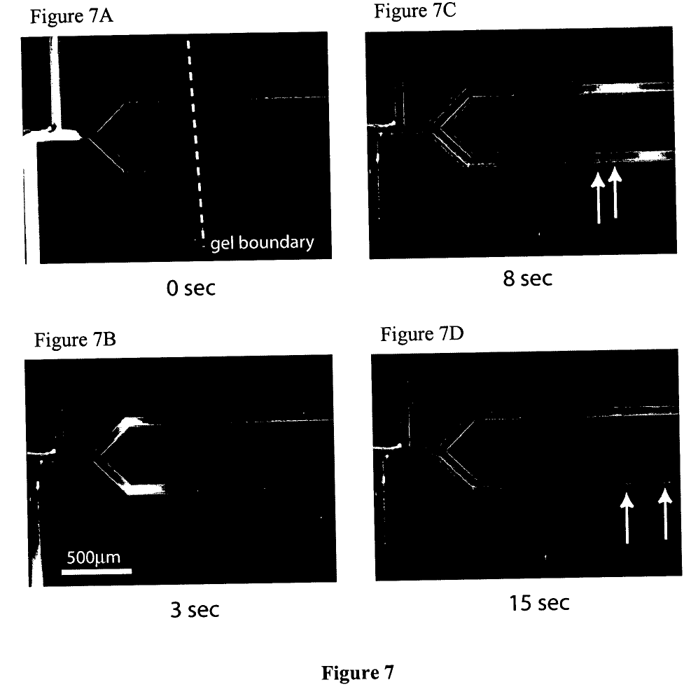

There are several reasons why separation within such a short time and distance may be achieved. First, the width of the initial protein band is much narrower due to the microfluidic sample injection system using electrokinetic sample manipulation described herein and this initial band is further stacked at the boundary between the polyacrylamide gel and free buffer regions. In FIG. 6B, the initial peak launched at the sample injection cross region has a width of about 200 μm. The cross region is the region where the sample (e.g. white bands in FIG. 7A) is trapped. As shown in FIG. 7A, a sample solution was fed from the sample reservoir (from the top of FIG. 7A) into the cross region (where two vertical side channels are connected to the one main horizontal channel. However, when protein samples enter the polyacrylamide gel region, the protein samples are retarded and stacked into a narrower band due to the sieving effect of the gel. FIGS. 7A-7D show the stacking of the protein band at the gel interface at various times. The first peak is myosin, the second peak is beta-glactosidase, the third peak is bovine serum albumin, the fourth peak is alcohol dehydrogenase, the fifth peak is carbonic anhydrase, the sixth peak is trypsin inhibitor, and the seventh peak is free dye. When the protein band entered the gel-filled region of the microchannel, the overall peak width became smaller depending on the mobility of the protein in the gel. It can be shown that the separation of peaks occurs as soon as proteins entered the gel region. Second, solid polyacrylamide gel has much higher sieving power than liquid gel (typically neutral polymer solution) because its structure (random nanoporous structure) ensures more interaction between SDS-coated protein polymer and gel matrix. Third, the applied field in the gel is about an order of magnitude higher than typical electric field values in standard slab gel SDS-PAGE, allowing faster separation. The electric field applied to the gel was changed from about 34 V/cm up to about 170 V/cm, and electrophoresis ran at higher field yielded faster separation result without significant changes in separation resolution.

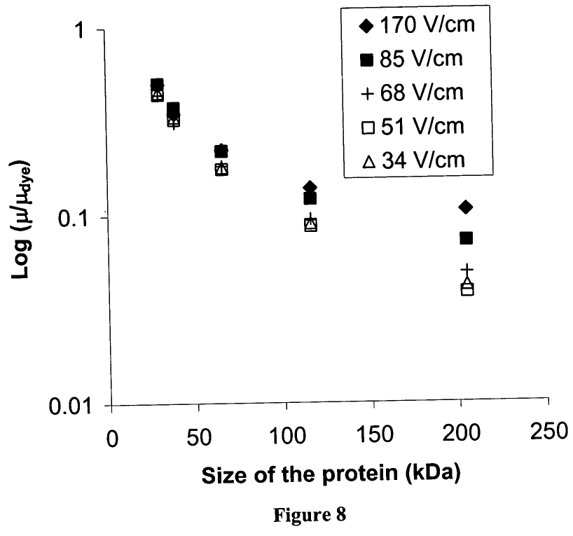

The concentration of the acrylamide gel used was 12%, which is a concentration that is typically used for separating low-molecular weight proteins in conventional slab SDS-PAGE. Depending on the desired separation or analysis, other gel concentrations may be used. One skilled in the art may readily adjust the concentration of the gel using methods known in the art. Protein samples were retarded significantly in the gel, which stacked the protein band into narrower one and enhancing the separation resolution. However, protein peaks were still mobilized through the gel and were not completely stuck in the gel matrix, mainly because of a higher driving electric field. FIG. 8 shows the relation between the measured mobility and the length of proteins separated at various electric field conditions.

According to the Ogston model of sieving, log(μ) should be proportional to R² (R:the radius of gyration of polymer molecule), and R²˜N (length of the polymer) assuming that SDS-coated proteins are ideal polymers. Therefore, the log(μ) versus N graph should be linear. The graph in FIG. 8 shows significant deviation from linear behavior, and may suggest that the mobility of longer proteins are higher than the values that the Ogston model would have predicted, thereby indicating that SDS-coated proteins are not well characterized as ideal polymers. However, the high electric field could have caused conformation change of proteins in the gel, thereby allowing them to migrate much easier. Similar dynamic transition in polymer dynamics has been well established in the DNA electrophoresis. See Slater, G W, and Noolandi, (1985) J. Phys. Rev. Lett. 55:1579-1582, which is herein incorporated by reference.

Another important advantage of using polyacrylamide gel instead of liquid gel in chip-based protein separation can be found in relation to the integration of protein separation to higher-level systems, commonly known as micro-total analysis systems. Integration of high voltage power supply is one of important engineering issues whenever a portable chemical and biological analysis system is considered. Because of higher sieving power of polyacrylamide gel than liquid sieving matrix, it is possible to decrease the length of the separation microchannel in the order of millimeters, while requiring relatively low electrical potential (about 10 V instead of kilovolts typically used in microfluidic electrophoresis separation) to generate comparable or even higher driving electric field in the microchannel. In addition, polyacrylamide gel would be easier to connect with other sample preparation or separation systems than liquid sieving matrix, since there is no concern of mixing and diluting the liquid sieving matrix when the separation microchannel is connected with other fluidic components. Possibility of patterning gel using the photopolymerization technique provides additional flexibility in design. It is possible to pattern polymer gel matrix with diverse properties within the microfluidic channel, and use the patterned gel as a nanoporous material to filter or manipulate biomolecules in the system. These advantages will become more important when one designs the microfluidic 2-D protein separation systems, which is potentially critical in future proteomics research. Thus, in preferred embodiments, the multidimensional electrophoresis device of the present invention employs at least one solid sieving material such as a solid polymer gel.

In addition to the ability to pattern different polymers in different channels, photopolymerization also allows us to make “gradient” gel in a channel where in the percentage of polymer changes from one end of the channel to the other in a linear fashion. The gradient gels allow one to separate, in one channel, protein mixture that contains proteins of both very small and very large molecular mass. The gradient gels can be made by mixing two concentrations of monomer in a mixing device prior to introduction in the channel. Once the gradient of monomer (e.g., acrylamide) has been introduced in the channel, the mixture is polymerized in situ by photoinitiation. A typical gradient used for polyacrylamide is about 4% to about 20% (w/v), however, other gradients may be used according to the present invention.

Suitable polymers of the invention comprise one or more of the following: acrylamide, agarose, methyl cellulose, polyethylene oxide, hydroxycellulose, hydroxy ethyl cellulose, and the like. Various types of acrylamide may be used, e.g. linear acrylamide, polyacrylamide, polydimethylacrylamide, polydimethylacrylamide/coacrylic acid, and the like.

A wide variety of alternative sieving mediums known in the art may be used. For example, sieving mediums suitable for use in chromatography, gel electrophoresis, and other liquid phase separations may be used. See e.g. Weiss (1995) Ion Chromatography VCH Publishers Inc.; Baker (1995) Capillary Electrophoresis John Wiley and Sons; Kuhn (1993) Capillary Electrophoresis: Principles and Practice Springer Verlag; Righetti (1996) Capillary Electrophoresis In Analytical Biotechnology CRC Press; Hill (1992) Detectors For Capillary Chromatography John Wiley and Sons; Gel Filtration: Principles and Methods (5th Edition) Pharmacia; Gooding and Regnier (1990) HPLC of Biological Macromolecules: Methods and Applications (Chrom. Sci. Series, volume 51) Marcel Dekker and Scott (1995) Techniques and Practices of Chromatography Marcel Dekker, Inc.; Affinity Chromatography—a Practical Approach, Dean et al. (Eds.) IRL Press, Oxford (1985); and Chromatographic Methods, 5th Edition, Braithwaite et al. (1996), which are herein incorporated by reference.

Other media may be incorporated into the polymer gels of the present invention. Suitable media include non-ionic macroreticular and macroporous resins, sephacryl, sephadex, sepharose, superdex, superose, toyopearl, agarose, cellulose, dextrans, mixed bead resins, polystyrene, nuclear resins, DEAE cellulose, Benzyl DEA cellulose, TEAE cellulose, silica gels, agarose based gels, acrylamide based gels, Genescan polymers, colloids and colloidial solutions, such as protein colloids (gelatins), and hydrated starches, and the like. Other media that may be incorporated into the polymer gels may also include affinity media for purification and separation of molecular components, such as acrylic beads, agarose beads, cellulose, sepharose, sepharose CL, toyopearl, or the like, chemically linked to an affinity ligand, such as a biological molecule. A wide variety of activated matrixes, amino acid resins, avidin and biotin resins, carbohydrate resins, dye resins, glutathione resins, hydrophobic resins, immunochemical resins, lectin resins, nucleotide/coenzyme resins, nucleic acid resins, and specialty resins are available and may also be used in the present invention.

The multidimensional electrophoresis device of the present invention may be made by photopolymerizing at least one sieving medium, such as a polymer gel on a solid substrate, photopatterning at least one sieving medium, such as a polymer gel on a solid substrate, or a combination thereof.

The sieving mediums of the invention are supplied in a liquid or fluidic phase and then polymerized to provide a solid polymer gel as a sieving matrix. In some preferred embodiments, the sieving medium polymerizes upon exposure to light, i.e. the sieving medium comprises a “photopolymerizable” polymer. The sieving medium may be selectively exposed to light using methods known in the art, such as photomasking techniques, in those regions where a polymerized gel is desired. See e.g. Throckmorton et al. (2002) Anal. Chem. 74:784-789, which is herein incorporated by reference. The unpolymerized sieving medium may then be removed or washed out of the unselected regions using electrokinetic flow or pressure.

Free-radical polymerizable monomers that photopolymerize, or can be made photopolymerizeable by the addition of, e.g., energy transfer dyes may be used according to the present invention. For example, free-radical polymerizable monomers such as acrylamide, substituted acrylamides, acrylate, methacrylate, vinyl ester functionalized materials, and the like may be used as well as Monomers and/or oligomers of (meth)acrylates (meth)acrylamides, acrylamides, vinyl pyrrolidone and azalactones such as mono-, di-, or poly-acrylates and methacrylates such as methyl acrylate, methyl methacrylate, ethyl acrylate, isopropyl methacrylate, isooctyl acrylate, isobornyl acrylate, isobornyl methacrylate, acrylic acid, n-hexyl acrylate, stearyl acrylate, allyl acrylate, glycerol diacrylate, glycerol triacrylate, ethylene glycol diacrylate, diethyleneglycol diacrylate, triethyleneglycol dimethacrylate, 1,6-hexanediol diacrylate, 1,3-propanediol diacrylate, 1,3-propanediol dimethacrylate, trimethanol triacrylate, 1,2,4-butanetriol trimethylacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyl-dimethylmethane, bis[1-(3-acryloxy-2-hydroxy)]-propoxyphenyl dimethylmethane, tris-hydroxyethyl isocyanurate trimethacrylate; the bis-acrylates and bis-methacrylates of polyethylene glycols of molecular weight 200-500, copolymerizable mixtures of acrylated monomers, acrylated oligomers, PEG diacrylates, and the like. Strongly polar monomers such as acrylic acid, acrylamide, itaconic acid, hydroxyalkyl acrylates, or substituted acrylamides or moderately polar monomers such as N-vinyl-2-pyrrolidone, N-vinyl caprolactam, and acrylonitrile may also be used.

Proteins such as gelatin, collagen, elastin, zein, and albumin, whether produced from natural or recombinant sources, which are made by free-radical polymerization by the addition of carbon-carbon double or triple bond-containing moieties, including acrylate, diacrylate, methacrylate, ethacrylate, 2-phenylacrylate, 2-chloroacrylate, 2-bromoacrylate, itaconate, oliogoacrylate, dimethacrylate, oligomethacrylate, acrylamide, methacrylamide, styrene groups, and other biologically acceptable photopolymerizable groups, can also be used according to the present invention.

A number of photoiniators, well known in the art, can be used. One such group of initiators is azo-polymerization initiators including 2,2′-azobis (2-amidinopropane) dihydrochloride; 2,2′-azobis 2-methyl-N-(2-hydroxyethyl) propionamide; 2,2′-azobisisobutyronitrile; 2,2′-azobis(N,N′-dimethyleneisobutyramidine) dihydrochloride; 2,2′-azobis (N,N′-dimethyleneisobutyramidine); 4,4′-azobis(4-cyanopentanoic acid); 2-(carbamoylazo) isobutyronitrile; 2,2′-azobis(4-methoxy 2,4-dimethylvaleronitrile); Dimethyl 2,2″-azobisisobutyrate; 2,2′-azobis(2-metyhl butyronitrile).

Another group of initiators include IRGACURE® photoiniators from Ciba Specialty Chemicals Inc.

Dye-sensitized polymerization is well known in the art. For example, light from an argon ion laser (514 nm), in the presence of a xanthin dye and an electron donor, such as triethanolamine, to catalyze initiation, may be used to induce a free radical polymerization of acrylic groups in a reaction mixture. See Neckers, et al. (1989) Polym. Materials Sci. Eng. 60:15; and Fouassier, et al. (1991) Makromol. Chem. 192:245-260, which are herein incorporated by reference. Suitable photosensitive dyes for initiating polymerization include ethyl eosin, eosin Y, fluorescein, 2,2-dimethoxy-2-phenyl acetophenone, 2-methoxy,2-phenylaceto-phenone, camphorquinone, rose bengal, methylene blue, erythrosin, phloxime, thionine, riboflavin, methylene green, acridine orange, xanthine dye, thioxanthine dye, and the like.

Cocatalysts useful with photosensitive dyes include primary, secondary, tertiary or quaternary amines, triethanolamine, triethylamine, ethanolamine, N-methyl diethanolamine, N,N-dimethyl benzylamine, dibenzyl amine, N-benzyl ethanolamine, N-isopropyl benzylamine, tetramethyl ethylenediamine, potassium persulfate, tetramethyl ethylenediamine, lysine, ornithine, histidine, arginine, and the like. Examples of a dye/photoinitiator system include ethyl eosin with an amine, eosin Y with an amine, 2,2-dimethoxy-2-phenoxyacetophenone-, 2-methoxy-2-phenoxyacetophenone, camphorquinone with an amine, and rose bengal with an amine.

In some cases, dye may absorb light and initiate polymerization, without any additional initiator such as an amine. In these cases, only the dye and a monomer need be present to initiate polymerization upon exposure to light. The generation of free radicals is terminated when the laser light is removed. For example, 2,2-dimethoxy-2-phenylacetophenone does not require any auxiliary amine to induce photopolymerization.

Suitable light sources include various lamps and lasers such as a mercury lamp, longwave WV lamp, He-Ne laser, an argon ion laser, and the like. Preferred light sources are those which have a wavelength of about 320 to about 800 nm. In some preferred embodiments, a UV source is used to polymerize a UV photopolymerizeable gel. One skilled in the art may readily select an appropriate light source based upon the chemistry of the polymer to be affected by the source.

The solid substrate to which the polymer gel is polymerized upon may be any support that can be employed in the invention, e.g., polydimethylsiloxane (PDMS), film, glass, silicon, modified silicon, ceramic, plastic, or any type of appropriate polymer such as (poly)tetrafluoroethylene, or (poly)vinylidenedifluoride. In preferred embodiments, the solid substrate is PDMS or glass. The solid substrate can be any shape or size, and can exist as a separate entity or as an integral part of any apparatus, e.g., bead, cuvette, plate, vessel, and the like. The solid substrate may be treated such that the polyacrylamide adheres to the glass, e.g., by treatment with γ-methacryl-oxypropyl-trimethoxysilane, or by other methods known in the art. See e.g. European Patent Application 0 226 470, which is herein incorporated by reference. The solid substrate may also include electronic circuitry used in the detection of bit molecules, or microfluidics used in the transport of molecules.

The use of solid gels in the multidimensional electrophoresis device of the present invention avoids the problems associated with the mixing of liquid gels and provides better sieving power and allows faster separation within a shorter length. Thus, the present invention provides multidimensional electrophoresis devices that provide better sieving power and faster separation within shorter lengths.

Additionally, the solid gels in the devices of the present invention may be photo-patterned to allow sample stacking (compressing the initial sample band into a narrower sample band which generally increases the separation resolution), sample trapping, sample sieving and separation, and the like.

The samples to be analyzed may be injected electrokinetically using a cross-channel with the sample microchannel perpendicular to the separation microchannel. For example, a short pulse of a low electric filed, about 10 V/cm for about 10 to about 20 seconds, is applied between the ends of the separation microchannel, thereby compacting the sample at the gel interface. After compaction, the field is switched off and the injection ports are flushed with a buffer solution or electric fields can be used to electronically flush excess sample from entering the separation matrix. Then the filed is switched back on and increased to the level used during the actual separation.

The multidimensional electrophoresis devices of the present invention may be fabricated by methods known in the art. See e.g., Reyes, D R, et al. (2002) Anal. Chem. 74:2623-2636, which is herein incorporated by reference.

C. Channel Separation Using Polymeric Membranes

In some embodiments, the multidimensional electrophoresis device of the present invention may further comprise at least one polymeric membrane which isolates at least two separation microchannels. In this embodiment, the problem of incompatible reagents of two or more separation schemes is overcome. For example, the reagents for the second dimension, such as SDS-PAGE, may be prevented from entering the first dimension separation, such as IEF, thereby allowing unhindered operation of the first dimension separation and a quick transfer of the sample to the second dimension for analysis. This type of fluid control is similar to that described by Unger M A et al. (2000) Science, 288:113-116, which is herein incorporated by reference.

Thus, in some embodiments, a polymeric membrane is formed or placed at the top of a microfluidic channel in the device. In preferred embodiments, the polymeric membrane is thin and flexible, thereby allowing the membrane to be bent and deformed to block out the microchannel when sufficient force is applied. The polymeric membrane may be made by methods known in the art. See Unger, M A, et al. (2002) Anal. Chem. 74:2451-2457, which is herein incorporated by reference.

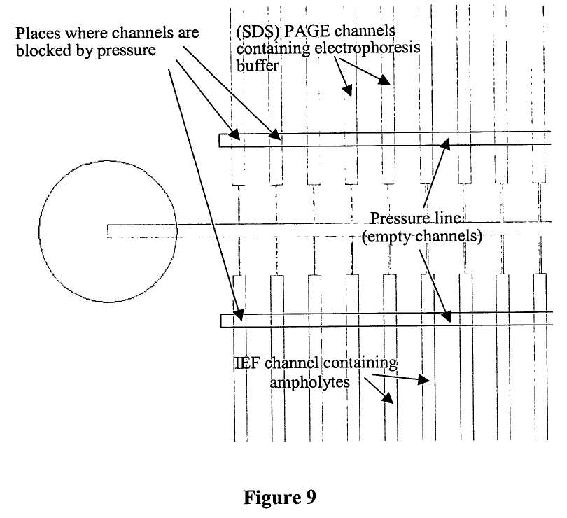

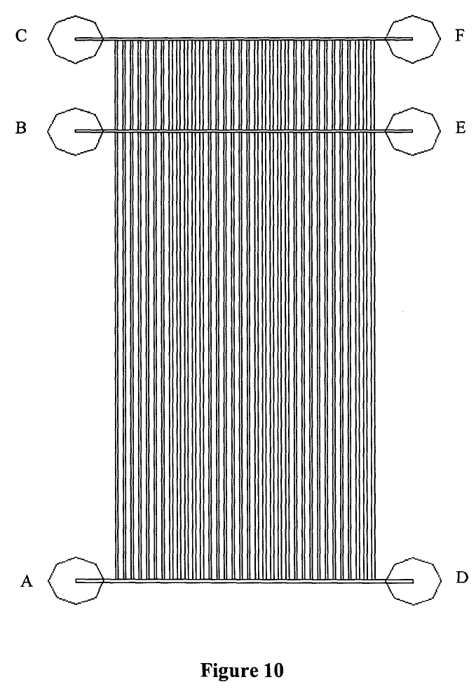

For example, as provided in Example 2 and as shown in FIG. 9, an empty cross channel may be fabricated over the microchannels to provide pressure to the microchannels, thereby resulting in closure of the microchannels. While IEF analysis is being conducted, the microchannels may be kept closed so that the ampholyte and electrophoresis buffer do not mix with each other. Furthermore, closure of the microchannel will prevent current leakage to the PAGE microchannels.

At the end of IEF run, the pressure applied to these membranes is removed and the microchannels open up. Then the electrophoresis buffers are able to migrate to the focused proteins in the IEF microchannel, either by diffusion or electromigration, to replace the ampholyte and make the proteins charged again. Only then can the proteins be driven to the PAGE microchannel by electrophoresis.

In preferred embodiments, the microchannel is opened quickly such that the focused protein peaks do not become dispersed by diffusion.

D. No Active Fluid Control

The multidimensional electrophoresis device of the present invention may lack any active fluid control. For example, FIG. 10 shows a device comprising six independent fluidic reservoirs/electrodes. IEF experiments are done between B and E reservoirs, while all the vertical microchannels are filled with either solid or liquid gel with electrophoresis buffer. During the operation, the electric potential of A, B, and C reservoirs are kept at the same high potential while D, E, F are grounded. Then, there will be no electric potential in the vertical microchannels that can render ampholytes and electrophoresis buffers to be mixed up in a manner other than diffusion. Since diffusion is relatively slow, unhindered IEF separation may be achieved by the existence of the vertical second dimension microchannel if the length of the microchannel is short enough. Thus, in preferred embodiments, the microchannel length is short, about 1 mm to about 100 mm and more preferably about 5 mm to about 50 mm or less. After the peaks are focused in the B-E microchannels, analysis can be switched to the second dimension and the proteins may be made to migrate into the vertical microchannels by applying an electric field between A-D and C-F.

The following examples are intended to illustrate but not to limit the invention.

### EXAMPLE 1

### IEF and SDS-PAGE in Short Microchannels

To demonstrate IEF and SDS-PAGE in a short microchannel, various straight microchannels were fabricated on poly(dimethylsiloxane) (PDMS) and glass substrates according to methods known in the art. See Duffy, D C, et al. (1998) Anal. Chem. 70:4974-4984; and Throckmorton, D J, et al. (2002) Anal. Chem. 74:784-789, which are herein incorporated by reference. An inverted microscope (IX-70, Olympus, Melville, N.Y.) was used as an experimental platform, and a cooled charge-coupled device (CCD) camera (CoolSNAP HQ™, Roper Scientific, Trenton, N.J.) connected to the microscope was used as an imaging device. The images from the camera were digitized and analyzed by imaging software (Image-Pro® Plus, Media Cybernetics, Silver Spring, Md.).

A. IEF Experiments

To demonstrate IEF in a short microchannel, various straight microchannels were fabricated on a PDMS substrate, as well as a glass substrate. Two naturally-fluorescent proteins, enhanced green fluorescent protein (EGFP, BD Biosciences, Palo Alto, Calif.) and R-phycoerythrin (Molecular Probes, Eugene, Oreg.), and one labeled protein, Carbonic Anhydrase II (Sigma, St. Louis, Mo.), were used. Carbonic anhydrase was labeled by rhodamine-maleimide, which binds to the cysteine residue of the protein. Unlike conventional lysine specific-labeling methods, rhodamine-maleimide labeling is not expected to significantly shift the pI of Carbonic Anhydrase II. Carbonic anhydrase at a concentration of 0.1 mM was reacted with 20-fold molar excess of rhodamine-maleimide at pH 7.0 for 12 hours at 4° C. The excess rhodamine-maleimide was separated from labeled protein by size exclusion chromatography. Commercially available ampholyte (cIEF ampholyte, Beckman Coulter, Fullerton, Calif.) was used at a concentration of 2%. Proteins were added to the ampholyte mixture to make the final concentration of about 1 μg/ml for each protein species. 40 mM phosphoric acid and 20 mM sodium hydroxide solutions were used as anolyte and catholyte, respectively.

For the PDMS microchannel experiments, a 1% methylcellulose solution was first introduced into the microchannel to coat the surface, just before the experiment. In addition, as a dynamic coating agent, methylcellulose was added to the ampholyte mixture, as well as the catholyte and the anolyte, at a concentration of about 0.5 to about 1%. Other coating agents known in the art that reduce electroosmotic flow may be used. The level of liquid in both (catholyte and anolyte) reservoirs was maintained to be the same to prevent hydrodynamic flow due to liquid level difference.

IEF separation of protein samples was achieved in a microfluidic channel as short as about 4 mm in about 45 seconds. As shown in FIG. 1, three proteins were focused within a microchannel made out of PDMS. EGFP and R-phycoerythrin are naturally fluorescent proteins, while carbonic anhydrase II proteins were visualized by cysteine-specific labeling (rhodamine-maleimide). To visualize all three peaks at once, two fluorescent images taken at different excitation wavelengths were merged into a single image electronically. The two peaks observed for the carbonic anhydrase II protein are charge isomers of the same protein, as observed previously. See Radko, S P, et al. (2002) Electrophoresis 23:985-992, which is herein incorporated by reference.

FIG. 6A shows two parallel microchannels filled with solid polyacrylamide gel during the separation of protein markers. The left edge of the image roughly coincides with the beginning of solid gel in the microchannel. This fluorescence image was taken 25 seconds after launching the sample from the loading area. Six peaks were well separated in both microchannels. The width of separated bands was much narrower than that of initial band (about 200 μm), because the interaction of proteins with polyacrylamide gel matrix at the gel boundary stacks the protein bands.

B. SDS-PAGE Experiments

For SDS-PAGE separation in a chip, a glass microchip was coated by 3-(Trimethoxysilyl)propyl acrylate in an acidic environment, followed by the polymerization process of acrylamide monomer (about 5%) on the surface of the microchannel in order to decrease the electroosmotic flow in the open region of the glass microchannel. See Hjertén, S J (1985) J. Chromatogr. 347:191-198, which is herein incorporated by reference. Other methods known in the art for decreasing the electroosmotic flow may be used.

Then, sieving gel was formed by patterned UV exposure in the microchannel, for up to about 10 minutes. A solution of 12% acrylamide/bisacrylamide (ratio 37.5:1), 1×Tris-Cl (0.375 M) buffer (pH=8.6), 0.1% SDS, 0.2% VA-086 (2,2′-Azobis(2-methyl-N-(2-hydroxyethyl)propionamide)) (Wako chemicals, Richmond, Va.) was prepared and introduced into the microchannel. Upon UV light (350 nm) exposure, the 12% acrylamide/bisacrylamide solution turned into polyacrylamide gel within the microchannel. Only the separation microchannel region (not the sample loading region) was exposed by blocking the UV light with an optical mask.

After the polymerization, the unexposed section of the microchannel was flushed with 0.375 M Tris-Cl buffer comprising 0.1% SDS. The same solution was used as a sample buffer and buffers for other reservoirs. A commercially available fluorescence-labeled protein marker sample (product number F-3526, Sigma, St. Louis, Mo.) comprising rabbit muscle myosin (205 kD), beta-galactosidase from E. coli (116 kD), bovine serum albumin (66 kD), alcohol dehydrogenase from horse liver (39 kD), carbonic anhydrase from bovine erythrocyte (29 kD), and soybean trypsin inhibitor (20.1 kD) was used as a sample. The protein concentration was about 10 to about 100 μM for each species. The protein sample was introduced into the loading region of the microchannel by applying a negative potential to the sample reservoir. Loading, launching and separation of protein bands were monitored and recorded in real time by the cooled CCD camera.

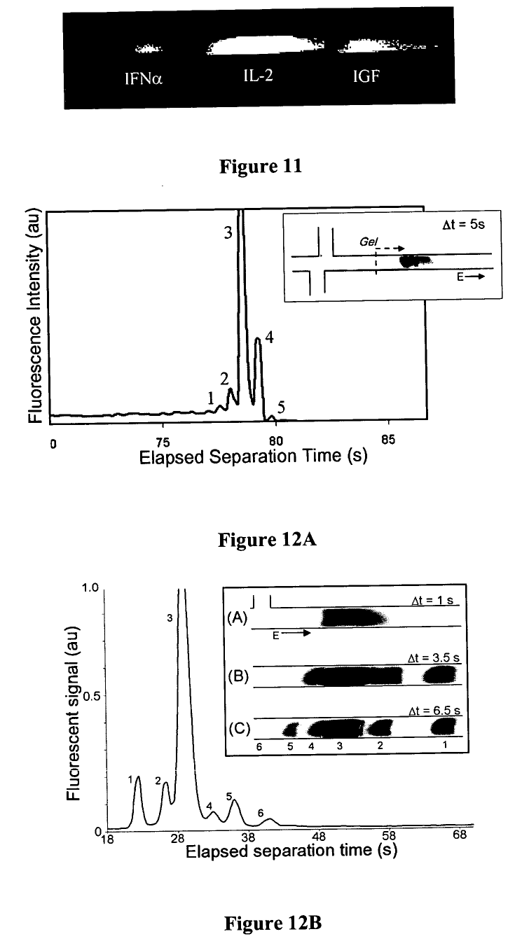

FIG. 11 shows a separation of cytokines by SDS-PAGE using a device according to the present invention. Specifically, FIG. 11 shows SDS-PAGE separation of three fluorescein-labeled cytokines. From left to right, the bands are IFN_{α} (19.2 kD), IL-2 (15.4 kD), and IGF (7.7 kD). SDS-PAGE was performed using a 15% cross-linked polyacrylamide gel according to the methods described herein. The running buffer was 0.375M TrisCl at pH 8.8 containing 0.1% SDS. The denatured FITC-cytokines were diluted in the running buffer to final concentrations of 10⁻⁶ M. The electric field was 125 V/cm. The microchannel dimensions were about 25 μm deep, about 50 μm wide and the separation channel length was about 1.0 cm and the injection arms were about 1.0 cm each. Epifluorescence microscopy was used to image the separations according to methods known in the art

C. Native PAGE Experiments

In many instances, proteins and protein complexes must be separated in their native state. Examples include multi-domain proteins, protein associated with other proteins or other molecules, immune complexes such as antibody-antigen, and other complexes such as ligand-receptor or enzyme-substrate analog. Native PAGE, where protein samples are not denatured by heating and SDS is not added, allows one to achieve such separations of proteins and protein complexes in their native state. The gel for native PAGE may be cast in the same way as described herein for SDS-PAGE except that SDS is omitted. Furthermore, no SDS is added to the protein sample.

FIG. 12A shows a fast native PAGE separation of 5 proteins of different molecular weights separated by native PAGE using a device according to the present invention. The separation was completed in less than about 90 seconds in about a 2.5 cm separation length. As show in FIG. 12A, the inset is an inverted grayscale CCD image of proteins beginning to resolve just 6 seconds after injection. The proteins are (1) apotinin (6.5 kDa), (2) α-lactalbumin (14.2 kDa), (3) trypsin inhibitor (20.1 kDa), (4) carbonic anhydrase 11 (29 kDa), and (5) alcohol dehydrogenase (30.8 kDa). E=450 V/cm. The microchannels were functionalized using acrylate-terminated self-assembled monolayers and subsequently coated with linear polyacrylamide. After channel coating, the channels were filled with a 1:1 solution of 30% acrylamide/bis-acrylamide and run buffer with 0.2% photoinitiator (V-50 or 2,2′-azobis (2-aminopropane)dihydrochloride) and, after masking, exposed to a UV source. Epi-fluorescence microscopy was used to acquire detailed spatial and temporal information during the separation according to methods known in the art. FIG. 12B shows another example where a fluorescently-labeled protein (FITC-IL2 or interleukin 2, MW 15.4 kDa) is analyzed in less than about 7 seconds by native PAGE according to the methods described herein. The electropherogram was collected at a point about 2.5 cm from the injector. The inset of FIG. 12B shows inverted grayscale CCD images of the sample at various times and various locations during the separation. As shown in the inset, (A) at 1 second, proteins were not resolvable, (B) at 3.5 seconds, the proteins began to-become resolvable, and (C) by 6.5 seconds, the proteins were nearly resolved.

### EXAMPLE 2

### Polymeric Membrane Isolation

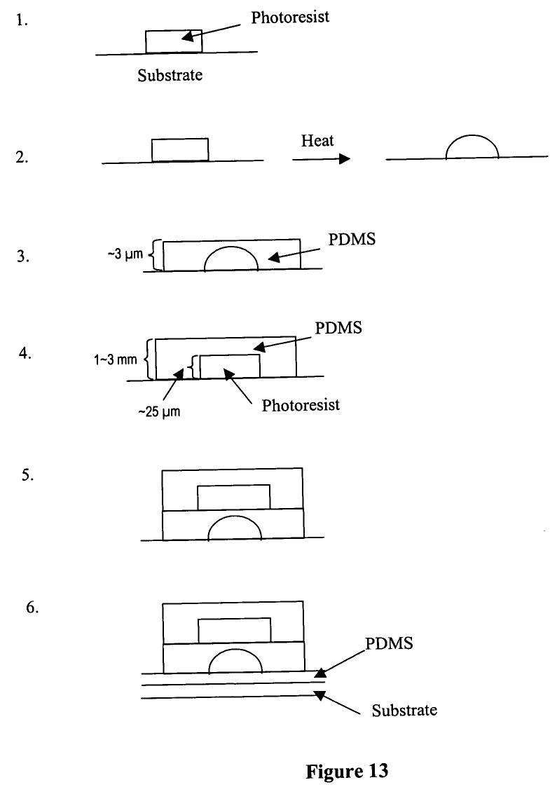

To isolate the separation microchannels of a multidimensional electrophoresis device, a polymeric membrane may be constructed and used. See Unger, M A, et al. (2000) Science 288:113-116, which is herein incorporated by reference. FIG. 13 schematically shows how the valveless multidimensional electrophoresis device may be constructed using a two-level method. First a master pattern is made out of photoresist on a substrate such as silicon. Second, the substrate is heated to round the edges of the pattern. Third, PDMS is spun over the photoresist to a height of about 30 μm. Fourth, to make the valve actuating microchannel, another master pattern of about 25 μm in height is made and a PDMS piece is spun over the second pattern to a height of about 1 to about 3 mm. Fifth, the construct from the fourth step is aligned and bonded on top of the construct from the third step using methods known in the art such as plasma and methanol treatments. Sixth, the construct from the fifth step is detached from the substrate and bonded to a flat layer of PDMS on a substrate such as glass.

### EXAMPLE 3

### Valveless Multidimensional Electrophoresis Device

IEF followed by gel electrophoresis may be conducted without using any active fluid control using a multidimensional electrophoresis device as shown in FIG. 10. As shown in FIG. 10, there are six, A-F, independent fluidic reservoirs/electrodes. IEF separations are conducted between reservoirs B and E (IEF microchannel comprising ampholyte), while all the vertical microchannels are filled with either solid or liquid gel and electrophoresis buffer. During IEF separations, the electric potential of reservoirs A, B, and C are kept at the same high potential (such as about 100 v) while reservoirs D, E, and F (such as 0 V) are grounded, whereby no electric potential in the vertical microchannels is present. Thus, ampholytes and electrophoresis buffer are not mixed due to the lack of an electric potential in the vertical microchannels. It is noted that the ampholytes and electrophoresis may be mixed due to diffusion, however, the amount of mixing would be negligible because such diffusion is relatively slow. Thus, IEF separation may be unhindered by the existence of the vertical second dimension microchannels when the IEF microchannel is short ( about 1 cm or less). After the peaks are focused in the IEF microchannel, B-E microchannel, separation using the second dimension may be conducted by applying an electric field between reservoirs A-D and C-F and letting the analytes such as proteins, migrate into the vertical microchannels.

To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A multidimensional electrophoresis device, for isoelectric focusing (IEF), or polyacrylamide gel electrophoresis (PAGE), or both of a fluid sample, comprising at least one microchannel having a length and a solid sieving material.

2. The multidimensional electrophoresis device, wherein the PAGE is dodecyl sulfate-polyacrylamide gel electrophoresis (SDS-PAGE) or native PAGE.

3. The multidimensional electrophoresis device of claim 1, wherein the length is about 1 millimeter to about 5 centimeters.

4. The multidimensional electrophoresis device of claim 1, wherein the length is about 1 millimeter to about 2 centimeters.

5. The multidimensional electrophoresis device of claim 1, wherein the length is about 1 millimeter to about 1 centimeter.

6. The multidimensional electrophoresis device of claim 1, wherein the length is about 1 to about 7 millimeters.

7. The multidimensional electrophoresis device of claim 1, wherein the length is about 1 to about 5 millimeters.

8. The multidimensional electrophoresis device of claim 1, wherein the solid sieving material is a solid polymer gel.

9. The multidimensional electrophoresis device of claim 1, wherein the solid sieving material is made by UV-initiated polymerization.

10. The multidimensional electrophoresis device of claim 9, wherein the solid sieving material made by UV-initiated polymerization is polyacrylamide.

11. The multidimensional electrophoresis device of claim 9, wherein the photoinitiator used is 2,2′-Azobis (2-amidinopropane) dihydrochloride.

12. The multidimensional electrophoresis device of claim 1, which comprises a plurality of microchannels and wherein the plurality of microchannels comprise different solid sieving materials.

13. The multidimensional electrophoresis device of claim 12, wherein the solid sieving materials are of varying concentrations of at least one polymer between about 4% to about 20% (wt/vol).

14. The multidimensional electrophoresis device of claim 1, wherein at least one microchannel contains a gradient gel where the concentration of photoinitiated polymer changes from a low w/v percentage to high w/v percentage from one end of the microchannel to the other.

15. The multidimensional electrophoresis device of claim 1, wherein at least one microchannel contains a gradient gel where the concentration of at least one photoinitiated polymer changes from about 4% w/v percentage to about 20% w/v percentage from one end of the microchannel to the other.

16. The multidimensional electrophoresis device of claim 1, and further comprising a loading structure.

17. The multidimensional electrophoresis device of claim 16, wherein the loading structure is shared with at least two microchannels.

18. The multidimensional electrophoresis device of claim 1, and further comprising a cross channel through which the fluid sample may be electrokinetically injected into the microchannel.

19. The multidimensional electrophoresis device of claim 1, and further comprising a channel through which at least one reagent may be added and come into contact with the fluid sample.

20. The multidimensional electrophoresis device of claim 19, wherein the reagent is a dye, a label, or a buffer solution.

21. The multidimensional electrophoresis device of claim 1, wherein the microchannel comprises at least one bypass fluidic channel.

22. The multidimensional electrophoresis device of claim 1, and further comprising at least one chamber wherein the sample to be tested can be processed or chemically modified prior to being separated or analyzed.

23. The multidimensional electrophoresis device of claim 1, and further comprising at least one chamber that contains at least one reagent for conducting IEF, SDS-PAGE, or native PAGE.

24. The multidimensional electrophoresis device of claim 1, and further comprising at least one polymeric membrane which isolates at least two microchannels.

25. The multidimensional electrophoresis device of claim 24, wherein one microchannel is for IEF and the other microchannel is for SDS-PAGE, or native PAGE.

26. The multidimensional electrophoresis device of claim 24, wherein the polymeric membrane is formed or placed on top of the microchannel.

27. The multidimensional electrophoresis device of claim 26, wherein pressure applied to the polymeric membrane will close the microchannel and prevent fluid or current movement through the microchannel.

28. The multidimensional electrophoresis device of claim 1, wherein IEF, SDS-PAGE, or native PAGE takes about 5 minutes or less to perform.

29. The multidimensional electrophoresis device of claim 1, wherein IEF, SDS-PAGE, or native PAGE takes about 2 minutes or less to perform.

30. The multidimensional electrophoresis device of claim 1, wherein IEF, SDS-PAGE, or native PAGE takes about 1 minute or less to perform.

31. The multidimensional electrophoresis device of claim 1, wherein IEF, SDS-PAGE, or native PAGE takes about 30 seconds or less to perform.

32. The multidimensional electrophoresis device of claim 1, wherein IEF, SDS-PAGE, or native PAGE takes about 10 to about 30 seconds to perform.

33. The multidimensional electrophoresis device of claim 1, wherein the fluid sample comprises at least one protein.

34. The multidimensional electrophoresis device of claim 1, wherein IEF is conducted in at least one horizontal microchannel between two electrodes and SDS-PAGE or PAGE is conducted in at least one vertical microchannel between two pairs of electrodes, wherein one pair of electrodes is placed above the two electrodes of the horizontal microchannel and the other pair of electrodes is placed below the two electrodes, whereby conducting IEF when the electrodes on the right side are of one voltage and the electrodes on the left side are of another voltage prevents the fluid sample from migrating through the vertical microchannel.

35. An assay for analyzing a fluid sample which comprises using the multidimensional electrophoresis device of claim 1.

36. An assay for analyzing a fluid sample which comprises using the multidimensional electrophoresis device of claim 24.

37. An assay for analyzing a fluid sample which comprises using the multidimensional electrophoresis device of claim 34.

38. A kit for analyzing a fluid sample which comprises the multidimensional electrophoresis device of claim 1 packaged together with at least one reagent necessary for conducting IEF or PAGE separations.

39. The kit of claim 38, and further comprising a device for injecting the fluid sample into the multidimensional electrophoresis device.

40. The kit of claim 38, and further comprising a label, at least one reagent, at least one device, or at least one means for obtaining a visually observable result.
